(19) United States
(12) Patent Application Publication
(10) Pub. No.: US 2024/0336769 A1
(43) Pub. Date: Oct. 10, 2024

(54) POLYMER RECYCLATE BLEND PRODUCTS

(71) Applicant: Equistar Chemicals, LP, Houston, TX (US)

(72) Inventors: Gang Zhang, Mason, OH (US); Hrishikesh R. Munj, Cincinnati, OH (US); Mick C. Hundley, Loveland, OH (US)

(73) Assignee: Equistar Chemicals, LP, Houston, TX (US)

(21) Appl. No.: 18/629,667

(22) Filed: Apr. 8, 2024

Related U.S. Application Data
(60) Provisional application No. 63/458,291, filed on Apr. 10, 2023.

(51) Int. Cl. C08L 23/08; C08J 11/24

(52) U.S. Cl. CPC C08L 23/0846; C08J 11/24; C08J 2323/08; C08J 2423/08; C08L 2205/08; C08L 2207/062; C08L 2207/20

(57) ABSTRACT

Compositions comprising a mixture of a polymer recyclate and a compatibilizer are provided. The polymer recyclate comprises a first low polarity polymer having an oxygen vapor transmission rate (OVTR) greater than or equal to 800 cc·μm/m²·day·atm and a high polarity polymer, comprising at least one polar monomer and having an OVTR less than or equal to 200 cc·μm/m²·day·atm. The compatibilizer comprises a second low polarity polymer grafted with one or more functional groups. The mixture is subjected to compounding conditions to form a polymer product having a dispersed phase of domains of the high polarity polymer in a matrix phase of the first low polarity polymer. Methods for producing such compositions by recycling barrier films are also provided, wherein the barrier film comprises at least one layer of the first low polarity polymer and at least one layer comprising the high polarity polymer, as described above.

### CROSS-REFERENCE TO RELATED APPLICATIONS

This application claims the benefit of priority to U.S. Provisional Application No. 63/458,291 filed on Apr. 10, 2023, which is incorporated herein by reference in its entirety.

### FIELD OF THE INVENTION

The present disclosure relates to polymer products and methods for producing such products by blending a polymer recyclate and a compatibilizer, wherein the polymer recyclate comprises a first polyolefin component and a polar polymer component having one or more polar monomers and/or comonomers.

### BACKGROUND OF THE INVENTION

Polyolefins, in particular polyethylene, is increasingly consumed in large amounts for many applications, including packaging for food and other goods, electronics, automotive components, and a great variety of manufactured articles. Large amounts of waste plastic materials are presently coming from differential recovery of municipal plastic wastes, mainly constituted of flexible packaging (cast film, blown film and BOPP film), rigid packaging, blow molded bottles and injection molded containers. Usually, recovery of polymer recyclate includes a step of separation of various types of polymers prior to further processing.

Polyolefin/barrier multilayer packaging materials are used to combine the respective performance of different polymers in different layers. The multilayer structure package performs a combination of functions that is not possible with a single layer of on polymer. The multilayer packaging is created to protect sensitive food products sufficiently and obtain extended shelf life. An oxygen barrier can be provided by one or more barrier layers comprising polymers containing polar groups such as, but not limited to, ethylene vinyl alcohol copolymers (EVOH) or polyamide (nylon). Mechanical properties such as tear resistance and puncture resistance can be provided by one or more layers comprising nonpolar polyolefins such as, but not limited to, a linear low-density polyethylene (LLDPE) and/or high density polyethylene (HDPE).

Such multilayer packaging generally exhibits poor recyclability because of the dissimilar materials in such multilayer structures. When such multilayer structures are melted, the polar groups of the barrier layers do not disperse well in the nonpolar polymer matrix formed by the layers providing improved mechanical properties to the multilayer structure. This poor distribution of polar groups in such polymer recyclate results in poor processibility, mechanical properties, and/or optical properties. This results in disposal of such materials in landfill, thus counteracting efforts towards a circular economy.

There is a need to provide processes for improved recycling of such multilayer films and to produce compositions comprising such recycled materials having a useful combination of properties that are equal to or better than analogous virgin and/or segregated polymer compositions. Ideally, such processes would be highly flexible and could be implemented with commonly used equipment and familiar techniques to produce a wide variety of products.

### SUMMARY OF THE INVENTION

The present disclosure relates to compositions comprising a blend of a polymer recyclate and a compatibilizer. The polymer recyclate comprises a mixture of a first low polarity polymer and a high polarity polymer comprising at least one polar monomer. The compatibilizer comprises a second low polarity polymer grafted with one or more functional groups. The mixture is subjected to compounding conditions sufficient to form a polymer product having a dispersed phase of domains of the high polarity polymer in a matrix phase of the first low polarity polymer.

In some embodiments, the first low polarity polymer comprises: a copolymer of units derived from ethylene and units derived from one or more of C₃-C₂₀ alpha-olefins or mixtures thereof, a copolymer of units derived from ethylene and units derived from one or more of alpha mono-olefins comprising polar groups; or combinations thereof.

In some embodiments, the first and second low polarity polymers each have an oxygen vapor transmission rate (OVTR)greater than or equal to 800 cc·μm/m²·day·atm, and the high polarity polymer has an OVTR less than or equal to 200 cc·μm/m²·day·atm.

In some embodiments, the high polarity polymer comprises one or more members selected from the group consisting of ethylene vinyl alcohol, polyamide, polyvinylidene chloride, or polychlorotrifluoroethylene.

In some embodiments, the compatibilizer has one or more of:
a) a functional monomer content in a range of from 1.1 wt. % to 2.9 wt. %, based on the total weight of the compatibilizer;
b) a melt index (I₂) in the range of from 1.0 dg/min to 12.0 dg/min;
c) a density in the range of from 0.850 g/cm³ to 0.960 g/cm³;
d) a melt elasticity (ER) in the range of from 0.30 to 3.00; and
e) a melting temperature (Tₘ) in the range of from 51° C. to 145° C.

In some embodiments, the second low polarity polymer comprises an ethylene-based polymer, and the one or more functional groups comprise a member selected from the group consisting of an anhydride, a carboxylic acid, and combinations thereof.

In some embodiments, the first low polarity polymer is miscible with the second low polarity polymer, and the at least one polar monomer has interfacial reactivity with the one or more functional groups.

In some embodiments, the domains of the high polarity polymer have an average particle size having a cross-sectional area of less than or equal to 0.90 μm².

In some embodiments, the compatibilizer and the high polarity polymer are present in the composition in a weight ratio in a range of from 0.5:1.0 to 5.0:1.0.

In some embodiments, the first low polarity polymer comprises a first polyethylene, the high polarity polymer comprises an ethylene vinyl alcohol copolymer, and the compatibilizer comprises a second polyethylene grafted with maleic anhydride.

In some embodiments, the first polyethylene and the second polyethylene are the same or different.

The present disclosure further relates to a method for recycling a barrier film. The barrier film comprises at least one layer of a first low polarity polymer and at least one layer comprising a high polarity polymer comprising at least one polar monomer. The method comprises compounding the barrier film to form a polymer recyclate comprising a substantially homogeneous first mixture of the first low polarity polymer and the high polarity polymer. The first mixture typically contains gels formed by particles of the high polarity polymer not dispersed in the matrix phase of the low polarity polymer, wherein domains of the high polarity polymer have a particle size having a cross-sectional area of greater than 0.90 μm² as measured by scanning electron microscope (SEM). A compatibilizer is added to the polymer recyclate to form a second mixture, wherein the compatibilizer comprises a second low polarity polymer grafted with one or more functional groups. The second mixture is subjected to compounding conditions sufficient to form a polymer product having a dispersed phase of domains of the high polarity polymer in a matrix phase of the first low polarity polymer. Compounding of the second mixture results in a matrix phase of the first low polarity polymer having a reduced gel content, wherein the gels are formed by smaller particles of the high polarity polymer dispersed in the matrix phase of the low polarity polymer and the domains of the high polarity polymer have a particle size having a cross-sectional area of less than 0.90 μm² as measured by SEM.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other film structures and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE DRAWINGS

The claimed subject matter may be understood by reference to the following description taken in conjunction with the accompanying drawings, in which like reference numerals identify like elements, and in which:

FIG. 1 shows a graphical representation of the dart drop performance of films comprising blends of polymer recyclate and compatibilizers according to embodiments of the invention compared to films comprising virgin polymers and polymer recyclates without a compatibilizer;

FIG. 2 shows a graphical representation of the tear strength performance of films comprising blends of polymer recyclate and compatibilizers according to embodiments of the invention compared to films comprising virgin polymers and polymer recyclates without a compatibilizer;

FIG. 3 shows a graphical representation of the optical properties of films comprising blends of polymer recyclate and compatibilizers according to embodiments of the invention compared to films comprising virgin polymers and polymer recyclates without a compatibilizer;

FIG. 4 shows a graphical representation of the tensile break performance of films comprising blends of polymer recyclate and compatibilizers according to embodiments of the invention compared to films comprising virgin polymers and polymer recyclates without a compatibilizer; and,

FIG. 5 shows a graphical representation of the tensile elongation at break performance of films comprising blends of polymer recyclate and compatibilizers according to embodiments of the invention compared to films comprising virgin polymers and polymer recyclates without a compatibilizer.

While the disclosed process and composition are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

“Antioxidant agents,” as used herein, means compounds that inhibit oxidation, a chemical reaction that can produce free radicals and chain reactions. Antioxidants are differentiated based on their reaction mechanisms and include: (1) primary antioxidants, and (2) secondary antioxidants.

“Barrier layer,” as used herein, means a layer used in a multilayer film to impart gas impermeability in addition to other desired properties to a multilayer structure. Barrier layers herein comprise high polarity polymers.

“Compatibility,” as used herein, means the capability of the individual component substances in an immiscible polymer blend to exhibit interfacial adhesion, in which interfaces between phases or components are maintained by intermolecular forces, chain entanglements, or both, across the interfaces—i.e., holding together of two bodies by interfacial forces or mechanical interlocking on a scale of micrometers or less. Further discussion of miscibility can be found in D. W. Fox and R. B. Allen, ‘Compatibility’, Encyclopedia of Polymer Science and Engineering, 2nd Ed., J. I. Kroschwitz, ed., Wiley Interscience, New York, 1985, Vol. 3, p. 784. Work, W. J, Horie, K., Hess, M., & UK, R. S. (2004), Definitions of Terms Related to Polymer Blends, Composites and Multiphase Polymeric Materials, Pure and Applied Chemistry 76/11, the substance of which is fully incorporated herein by reference.

“Compounding conditions,” as used herein, means temperature, pressure, and shear force conditions implemented in an extruder to provide intimate mixing of two or more polymers and optionally additives to produce a substantially homogeneous polymer product. The compounding conditions will be such that the specific energy from the compounder from shear and/or added heat are sufficient to melt the polymer components and homogenize them.

“HDPE,” as used herein, means ethylene homopolymers and ethylene copolymers produced in a suspension, solution, slurry, or gas phase polymerization process and having a density in the range of 0.940 g/cm³ to 0.970 g/cm³.

“High polarity polymer,” as used herein, means a polar polymer comprising a sufficiently high amount of polar monomer and/or comonomer to result in the polar polymer having a low oxygen vapor transmission rate (OVTR), as measured by ASTM D3985, such as less than or equal to 200 cc·μm/m²·day·atm.

“LDPE,” as used herein, means ethylene homopolymers and/or ethylene copolymers produced in a high pressure free radical polymerization and having a density in the range of 0.910 g/cm³ to 0.940 g/cm³.

“LLDPE,” as used herein, means ethylene copolymers produced in a suspension, solution, slurry, or gas phase polymerization process and having a density in the range of 0.910 g/cm³ to 0.940 g/cm³.

“Low polarity polymer,” as used herein, means a polymer having a sufficiently low amount of polar monomer or comonomer to result in the low polarity polymer having a high oxygen vapor transmission rate (OVTR), as measured by ASTM D3985, such as greater than or equal to 800 cc·μm/m²·day·atm. In some embodiments, the low polarity polymer comprises a polyolefin having no polarity, a copolymer of an olefin (such as ethylene or propylene) and an alpha mono-olefin comprising polar group, or a combination thereof. Low polarity polymers have a high degree of miscibility and/or compatibility with other low polarity polymers and are further characterized as providing one or more of high moisture barrier, high tensile strength, high tear strength, and high puncture resistance as measure by dart drop.

“MDPE,” as used herein, means ethylene copolymers produced in a suspension, solution, slurry, or gas phase polymerization process and having a density in the range of 0.925 g/cm³ to 0.940 g/cm³.

“Miscibility,” as used herein, means the degree to which two polymers will mix to form a homogeneous polymer blends. Miscibility is the capability of a mixture to form a single phase over certain ranges of temperature, pressure, and composition. Whether or not a single phase exists depends on the chemical structure, molar mass distribution, and molecular architecture of the components present. A single phase in a mixture may be confirmed by light scattering, x-ray scattering, and/or neutron scattering. For a two-component mixture, a necessary and sufficient condition for stable or metastable equilibrium of a homogeneous, single-phase is:

$${( \frac{{\partial }^{2} {Δ}_{m i x} G}{\partial {∅}^{2}} )}_{T , p} > 0$$

wherein ΔₘᵢₓG is the Gibbs energy of mixing per unit volume, and (the composition, where (is usually taken as the volume fraction of one of the component substances. The system is unstable if the above second derivative is negative. The borderline (spinodal) between (meta)stable and unstable states is defined by the above second derivative equaling zero. Further discussion of miscibility can be found in J. M. G. Cowie, ‘Miscibility’, Encyclopedia of Polymer Science and Engineering, 2nd Ed., J. I. Kroschwitz, ed., Wiley Interscience, New York, 1985, Supplement, p. 455-480, and Work, W, J., Hoie, K., Hess, M., & UK, R. S. (2004), Definitions of Terms Related to Polymer Blends, Composites and Multiphase Polymeric Materials, Pure and Applied Chemistry 76/11, the substance of which is fully incorporated herein by reference.

“Multilayer film,” as used herein, means a coextruded structure comprising at least a barrier layer, a structural layer, and a tie layer.

“Nonpolar comonomer,” as used herein, means a monomer unit containing only carbon and hydrogen.

“Nonpolar polymer,” as used herein, means a polymer or copolymer consisting of units derived from a nonpolar monomers.

“Olefin,” as used herein, and alternatively referred to as “alkene,” is a linear, branched, or cyclic compound of carbon and hydrogen having at least one double bond.

“Polar monomer,” as used herein, means monomers containing highly electronegative atoms, such as chlorine, fluorine, oxygen, nitrogen, or sulfur, that give rise to polymers that contain permanent electric dipoles.

“Polar polymer,” as used herein, means a polymer or copolymer comprising units derived from a polar monomer. The term “polar polymer,” as used herein, refers to polymer formed from at least one monomer that comprises at least one heteroatom. Some examples of heteroatoms include O, N, P and S.

“Polymer recyclate,” as used herein, means post-consumer recycled (“PCR”) polyolefin and/or post-industrial recycled (“PIR”) polyolefin. Polyolefin recyclate is derived from an end product that has completed its life cycle as a consumer item and would otherwise be disposed of as waste (e.g., a polyethylene water bottle) or from plastic scrap that is generated as waste from an industrial process. Polymer recyclates herein are a mixture of a first low polarity polymer component and a high polarity polymer component comprising at least one polar monomer, such as produced by melting and mixing a barrier film having at least one layer of a first low polarity polymer component and at least on layer of a high polarity polymer component comprising at least one polar monomer.

“Polyolefin,” as used herein, in some embodiments is a type of polymer with the general formula (CH₂CHR)ₙ where R is an alkyl group, including, but not limited to LDPE, LLDPE, MDPE, HDPE, and PP. Polyolefins are nonpolar polymers.

“Functionalized polymer-based adhesive composition,” as used herein, means any composition comprising a functionalized polymer, alone or in combination with other polymers, where, in the context of coextruded layers of polymers, a layer of the functionalized polymer-based adhesive composition (or “tie layer”) will adhere better to both a first polymer layer and a second polymer layer than the first polymer layer and the second polymer layer would adhere to each other. Tie layers can also improve adhesion as described above where one or both polymer layers are replaced by a nonpolymeric layer.

“Primary antioxidants,” as used herein, means compounds which function essentially as free radical terminators or scavengers. Primary antioxidants react rapidly with peroxy and alkoxy radicals. The majority of primary antioxidants for polymers are sterically hindered phenols.

“Processability,” as used herein, refers to how well a polymer composition can be formed into a cast of blown film of commercial quality or molded by injection or compression molding into a molded article of commercial quality at commercially acceptable rates using the equipment and conditions.

“Secondary antioxidants,” as used herein, means compounds which are preventive antioxidants that function by retarding chain initiation. Secondary antioxidants react with hydroperoxides to yield non-radical products and are, therefore, frequently called hydroperoxide decomposers.

“Structural layer,” as used herein, means a layer used in a multilayer film to impart desired mechanical properties and/or resistance to moisture to the multilayer structure.

In the present description, the terms “monomer” and “comonomer” are used interchangeably. The terms mean any compound with a polymerizable moiety that is added to a reactor in order to produce a polymer. In those instances in which a polymer is described as comprising one or more monomers, e.g., a polymer comprising propylene and ethylene, the polymer, of course, comprises units derived from the monomers, e.g., —CH₂—CH₂—, and not the monomer itself, e.g., CH₂═CH₂. For example, when a copolymer is described as having an “ethylene” content of 35 wt. % to 55 wt. %, it is understood that the mer unit in the copolymer is derived from ethylene in the polymerization reaction and the derived units are present at 35 wt. % to 55 wt. %, based upon the weight of the copolymer.

In the present description, “multilayer film” is of particular concern and discussed throughout this description. When referring to a multilayer structure, the description can use a slash “/” to indicate that components to the left and right of the slash are in different layers and the relative position of components in layers can be so indicated by use of the slash to indicate layer boundaries.

The following abbreviations are used herein:

| ABBREVIATION | TERM |
|---|---|
| EAA | Copolymer of ethylene with acrylic acid |
| EAO | Copolymers of ethylene with at least one |
| | alpha-olefin |
| EMAA | Copolymer of ethylene with methacrylic acid |
| EVA | Copolymer of ethylene with vinyl acetate |
| EVOH | Saponified or hydrolyzed copolymer of |
| | ethylene and vinyl acetate |
| HDPE | High density polyethylene |
| Ionomer | Copolymers of ethylene and unsaturated |
| | carboxylic acid comonomers, such as but |
| | not limited to, EAA and EMAA |
| LDPE | Low density polyethylene |
| LLDPE | Linear low density polyethylene |
| MDPE | Medium density polyethylene |
| PA | Polyamides, such as nylon |
| PC | Polycarbonate |
| PCTFE | Polychlorotrifluoroethylene |
| PE | Polyethylene (an ethylene homopolymer or |
| | copolymer of a major portion of ethylene |
| | with one or more alpha-olefins and/or one |
| | or more polar comonomers) |
| PET | Polyethylene terephthalate |
| PETG | Glycol-modified polyethylene terephthalate |
| PP | Polypropylene homopolymer or copolymer |
| PS | Polystyrene |
| PVDC | Polyvinylidene chloride (also includes |
| | copolymers of vinylidene chloride, such |
| | as with vinyl chloride or methyl acrylate (MA)). |
| wt. % | weight percent |

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the disclosure.

### Multilayer Barrier Film

Wraps for meat and cheese, snack foods, baking mixes, and large bulk packaging for perishables, such as dog food, require multilayer structures to provide both structural integrity of packaging and resistance to transmission of oxygen and/or moisture.

Multilayer barrier films comprise at least one barrier layer. Such barrier layer or layers comprises a high polarity polymer, such as, but not limited to, EVOH, PA, PVDC, PCTFE, or a combination thereof. Such barrier layers have high clarity with excellent flex-crack resistance, and also some of the best barrier properties to gases such as oxygen, nitrogen, and carbon dioxide making it especially suited for packaging of food, drugs, cosmetics, and other perishable or delicate products to extend shelf life. In comparison with many other common films, high polarity polymers such as EVOH, PA, PVDC, and PCTFE have superior barrier properties. However, the good gas barrier properties of many high polarity polymers, such as EVOH and nylon, deteriorate when exposed to moisture.

Multilayer barrier films comprise at least one structural layer. Such structural layer or layers can comprise one or more polyolefins, one or more low polarity polymers, including polyolefins. Polyolefins, such as polyethylene and polypropylene, have superior moisture resistance properties and also provide essential mechanical properties such as, but not limited to, one or more of structural integrity, puncture resistance, heat resistance, heat sealability, and/or abrasion resistance. Nonpolar polyolefins include, but are not limited to, HDPE, LDPE, LLDPE, MDPE, and PP, which have superior moisture barrier properties, are frequently used in combination in multilayer, co-extruded films in order to achieve a desired balance of properties.

Low polarity polymers also provide one or more of structural integrity, moisture barrier, puncture resistance, heat resistance, heat sealability, and/or abrasion resistance. Such low polarity polymers include copolymers of units derived from ethylene and units derived from one or more of alpha mono-olefins comprising polar groups. Such low polarity polymers include, but are not limited to, EVA, ionomers (such as, but not limited to, EAA and EMAA), PET, PC, and/or PS, which provide one or more of moisture resistance, structural integrity, puncture resistance, heat resistance, heat sealability, and/or abrasion resistance. Low polarity polymers are frequently used in combination in multilayer, co-extruded films in order to achieve a desired balance of properties.

In some embodiments, one or more polyolefins and/or one or low polarity polymers are used individually in separate layers of a multilayer structure.

In some embodiments, one or more polyolefins and/or one or low polarity polymers are blended, and such blends are used in one or more layers of a multilayer structure.

One of ordinary skill in the art is familiar with the particular properties of barrier layers and structural layers and can select a combination of layers that will provide a balance of properties in the multilayer film for a desired application. However, layers having different mechanical properties often have chemical compositions that differ and result in such dissimilar layers not adhering well to one another.

In some embodiments, a multilayer barrier film comprises a structural layer and a barrier layer that do not adhere well to one another. In some embodiments, a multilayer barrier film comprises a high polarity polymer barrier layer and a structural layer comprising one or more low polarity polymers (including polyolefins), such that the barrier layer and the structural layer that do not adhere well to one another. In these embodiments, a tie layer comprising a functionalized polymer-based adhesive can be used between two dissimilar layers to provide the required level of adherence. In some embodiments, functionalized polymer-based adhesive compositions suitable for use as tie layers for multilayer constructions have good adhesion to both high polarity polymers and low polarity polymers (including polyolefins).

In some embodiments, the multilayer structure comprises:
(A) a first layer comprising a low polarity polymer;
(B) a second layer comprising a high polarity polymer layer; and,
(C) at least one tie layer between the first layer and the second layer.

The general process for forming the multilayer structure includes co-extruding the layers to form a multilayer structure. The multilayer structures can be in the form of films or sheets, which may be further thermoformed or oriented, and can be produced using conventional methods and extrusion equipment well known to those skilled in the art, where layers of polymer melts are combined by introducing multiple polymer melt streams into a combining block/manifold or die which then directs the melt streams to flow together (while still in the block/manifold or die), then exiting the die together as a single flow stream. Alternately, multiple polymer melt streams can be introduced into a die and then combined just after exiting the die.

### Structural Layer

In some embodiments, each of one or more structural layers comprise one or more polyolefins. In some embodiments, structural layers can be coextruded adjacent to another structural layer and/or one or more tie layers. In some embodiments, a structural layer is a blend of two or more polyolefins such as, but not limited to, a blend of low density polyethylene (LDPE), linear low density polyethylene (LLDPE), medium density polyethylene, high density polyethylene (HDPE), and/or polypropylene (PP).

In some embodiments, each of one or more structural layers comprise one or more low polarity polymers. In some embodiments, structural layers can be coextruded adjacent to another structural layer and/or one or more tie layers. In some embodiments, a structural layer is a blend of two or more low polarity polymers such as, but not limited to, a blend of EVA, ionomers (such as, but not limited to, EAA and EMAA), PET, PC, and/or PS.

In some embodiments, each of one or more structural layers comprise one or more polyolefins and one or more other structural layers comprise one or more low polarity polymers. In some embodiments, structural layers can be coextruded adjacent to another structural layer and/or one or more tie layers. In some embodiments, a structural layer is a blend of two or more of low density polyethylene (LDPE), linear low density polyethylene (LLDPE), medium density polyethylene, high density polyethylene (HDPE), polypropylene (PP), EVA, ionomers (such as, but not limited to, EAA and EMAA), PET, PC, and/or PS.

Suitable polyethylenes for structural layers include ethylene homopolymers and copolymers of units derived from ethylene and units derived from one or more of C₃-C₂₀ alpha-olefins or mixtures thereof. In some embodiments, the units derived from the one or more C₃-C₈ alpha-olefin comonomers are present in amounts up to 15 wt. %, based upon the total weight of the copolymer of ethylene. The ethylene homopolymers and copolymers can be produced using either Ziegler Natta catalyst, chromium-based catalyst, or single-site catalyst, e.g., metallocene catalyst. The ethylene homopolymers and copolymers can be produced using a gas phase process, high pressure process, slurry process, or solution process. Ethylene homopolymers and ethylene-C₃-C₈ alpha-olefin copolymers include very low density polyethylene (VLDPE), low density polyethylene (LDPE), linear low density polyethylene (LLDPE), medium density polyethylene (MDPE) and high density polyethylene (HDPE). VLDPE is defined as having a density of 0.860 to 0.910 g/cm³, as measured by ASTM D-1505 “Column Method.” LDPE and LLDPE are defined as having densities in the range of from 0.910 to 0.930 g/cm³. MDPE is defined as having a density of 0.930 to 0.945 g/cm³. HDPE is defined as having a density of at least 0.945 g/cm³, preferably from 0.945 to 0.969 g/cm³. The ethylene homopolymers and copolymers preferably have melt indexes (MIs), as measured by ASTM D 1238, condition 190° C./2.16 kg, from 0.01 to 400 dg/min, preferably, from 0.1 to 200 dg/min, more preferably from 1 to 100 dg/min

In some embodiments, LDPE is derived from ethylene homopolymers, copolymers of units derived from ethylene and units derived from one or more of C₃-C₁₂ alpha-olefins, copolymers of units derived from ethylene and units derived from one or more of alpha mono-olefins comprising polar groups, or mixtures thereof.

In some embodiments, LDPE homopolymers can be produced in a high pressure, free-radical polymerization process, such as in one or more tubular reactors, one or more autoclave reactors, or a combination thereof. Operating conditions for the high-pressure process can include, but are not limited to, a pressure in the range of from 70 MPa to 700 MPa and a temperature in the range of from 150° C. to 500° C. Such homopolymers have a high degree of long-chain branching and a density in the range of from 0.910 g/cm³ to 0.940 g/cm³.

In some embodiments, LDPE copolymers of ethylene and C₃-C₁₂ alpha-olefins can be produced in a high pressure, free-radical polymerization process, such as in one or more tubular reactors, one or more autoclave reactors, or a combination thereof. Such C₃-C₁₂ alpha-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts up to 15 wt. %, 10 wt. %, or 5 wt. %. Operating conditions for the high-pressure process can include, but are not limited to, a pressure in the range of from 70 MPa to 700 MPa and a temperature in the range of from 150° C. to 500° C. Such homopolymers have a high degree of long-chain branching and a density in the range of from 0.910 g/cm³ to 0.940 g/cm³.

In some embodiments, LDPE copolymers of ethylene and one or more of alpha mono-olefins comprising polar groups can be produced in a high pressure, free-radical polymerization process, such as in one or more tubular reactors, one or more autoclave reactors, or a combination thereof. Such alpha mono-olefins comprising polar groups include, but are not limited to, methacrylic acids, esters (e.g., acetate esters, such as vinyl acetate), nitriles, and amides, such as acrylic acid, methacrylic acid, cyclohexyl methacrylate, methyl acrylate, acrylonitrile, acrylamide, or mixtures thereof. When present, comonomers can be present in amounts up to 15 wt. %, 10 wt. %, or 5 wt. %. Operating conditions for the high-pressure process can include, but are not limited to, a pressure in the range of from 70 MPa to 700 MPa and a temperature in the range of from 150° C. to 500° C. Such homopolymers have a high degree of long-chain branching and a density in the range of from 0.910 g/cm³ to 0.940 g/cm³.

LDPE as described above, can be characterized by having: i) a density in the range of from 0.910 g/cm³ to 0.940 g/cm³ or from 0.915 g/cm³ to 0.935 g/cm³; ii) a melt index (2.16 kg, 190° C.) less than or equal to 5.0 g/10 min., less than or equal to 1.0 g/10 min., less than or equal to 0.5 g/10 min., less than or equal to 0.2 g/10 min., or less than or equal to 0.1 g/10 min.; iii) a molecular weight distribution (M_{w}/Mₙ) greater than 4.0, greater than 8.0, or greater than 15, and/or less than 35, less than 30, or less than 25; iv) a weight average molecular weight (M_{w}) greater than or equal to 100,000 daltons, greater than or equal to 150,000 daltons, greater than or equal to 200,000 daltons, or greater than or equal to 250,000 daltons, and/or less than or equal to 600,000 daltons, less than or equal to 500,000 daltons, less than or equal to 400,000 daltons, or less than or equal to 300,000 daltons; and v) a melt elasticity (“ER”) greater than or equal to 1.0, greater than or equal to 1.4, or greater than or equal to 2.0.

Suitable polypropylenes for structural layers include propylene homopolymers and copolymers, including plastomers, having of units derived from propylene and units derived one or more of ethylene and C₄-C₂₀ alpha-olefins or mixtures thereof. Preferably, the units derived from one or more of ethylene and C₄-C₁₀ alpha-olefin comonomers are present in amounts up to 35 wt. %, based upon the total weight of the copolymer of propylene. The propylene homopolymers and copolymers can be produced using either Ziegler Natta or single-site catalysts, e.g., metallocene catalysts. The propylene homopolymers and copolymers can be produced using a gas phase process, slurry process, or solution process. In some embodiments, when the propylene polymer is a copolymer, it preferably contains 2 to 6 wt. %, based upon the total weight of the copolymer, of ethylene derived units as a comonomer.

In some embodiments, a first low polarity polymer component comprises a copolymer of ethylene and one or more polar comonomer, a copolymer of propylene and one or more polar comonomers, or a combination thereof, wherein the low first polarity polymer component has an oxygen vapor transmission rate (OVTR), as measured by ASTM D3895, of greater than or equal to 800 cc·μm/m²·day·atm, greater than or equal to 900 cc·μm/m²·day·atm, or greater than or equal to 1,000 cc·μm/m²·day·atm.

A structural layer can also be formed from a blend of two or more polyethylenes, two or more polypropylenes, or one or more polyethylenes and one or more polypropylenes. In some embodiments, a structural layer can also be formed from a blend of two or more polyolefins, two or more low polarity polymers (other than polyolefins), or one or more polyolefins and one or more low polarity polymers (other than polyolefins).

### Barrier Layer

In some embodiments, the multilayer structure includes at least one barrier layer, comprising a polymer having an oxygen vapor transmission rate (OVTR), as measured by ASTM D3895, of less or equal to 200 cc·μm/m²·day·atm, less than or equal to 150 cc·μm/m²·day·atm, less than or equal to 100 cc·μm/m²·day·atm, or less than or equal to 50 cc·μm/m²·day·atm. A barrier layer can include EVOH, PA (e.g., nylons, such as nylon 6, nylon 6,6, nylon 12, nylon 6,12, nylon 6,66, and blends thereof, as well as co-extruded structures of EVOH and nylons, such as EVOH/nylon and nylon/EVOH/nylon. Barrier layers can also include polyvinylidene chloride (PVDC) and/or polychlorotrifluoroethylene (PCTFE). In some embodiments, the barrier layers are selected from EVOH, nylons or co-extruded structures thereof. In some embodiments, the barrier layer is EVOH.

### Tie Layer

In some embodiments, the tie layer comprises a functionalized polymer-based adhesive composition to improve the adherence between a low polarity polymer structural layer and a high polarity polymer barrier layer.

In some embodiments, the functionalized polymer-based adhesive composition is formed by melt blending a low polarity polymer with a functionalized polymer. In one or more embodiments, the low polarity polymer contacts the functionalized polymer prior to pelletization. In one or more other embodiments, the functionalized polymer contacts the low polarity polymer prior to pelletization.

In other embodiments, regardless of the blending of the low polarity polymer and the functionalized polymer, the process of combining the two components further includes melt blending the low polarity polymer and the functionalized polymer in the presence of adhesion promoting additive.

In some embodiments, the functionalized polymer is formed by addition of one or more pendant functional group to a polymer backbone comprising a second low polarity polymer. The low polarity polymer can be a polyolefin, such as an ethylene homopolymer or copolymer of ethylene and one or more alpha olefins. The low polarity polymer can be a copolymer of ethylene and one or more alpha mono-olefins comprising polar groups or a copolymer of propylene and one or more alpha mono-olefins comprising polar groups.

In some embodiments, the functionalized polymer-based adhesive composition includes the functionalized polymer in a range of from 0.5 wt. % to 30 wt. %, or 1 wt. % to 20 wt. %, or 2 wt. % to 15 wt. %, or 5 wt. % to 15 wt. %, or 6 wt. % to 11 wt. %, or 12 wt. % to 17 wt. %, based on the total weight of the functionalized polymer-based adhesive composition.

In some embodiments, a preferred composition of the functionalized polymer-based adhesive composition comprises a blend of LLDPE having a density in the range of from 0.910 to 0.930 g/cm³ with a HDPE having a density of at least 0.945 g/cm³, preferably from 0.945 to 0.969 g/cm³, the HDPE having been functionalized (e.g. grafted) with maleic anhydride (HDPE-g-MAH). In some preferred embodiments, the HDPE-g-MAH is present in the blend of LLDPE and HDPE-g-MAH in a range of from 0.5 wt. % to 30 wt. %, or 1 wt. % to 20 wt. %, or 2 wt. % to 15 wt. %, or 5 wt. % to 15 wt. %, or 6 wt. % to 11 wt. %, based on the total weight of the functionalized polymer-based adhesive composition.

In other embodiments, a preferred composition of the functionalized polymer-based adhesive composition comprises a blend of LLDPE having a density in the range of from 0.910 to 0.930 g/cm³ with another LLDPE having a density of 0.910 to 0.930 g/cm³, the LLDPE having been functionalized with maleic anhydride (LLDPE-g-MAH). In some preferred embodiments, the LLDPE-g-MAH is present in the blend of LLDPE and LLDPE-g-MAH in a range of from 0.5 wt. % to 30 wt. %, or 1 wt. % to 20 wt. %, or 2 wt. % to 15 wt. %, or 5 wt. % to 15 wt. %, or 6 wt. % to 11 wt. %, based on the total weight of the functionalized polymer-based adhesive composition.

Examples of functionalized polymer-based adhesive compositions are disclosed in U.S. Patent Publication Nos. 2017/0198103 and 2017/0335149, and U.S. Pat. Nos. 7,687,575, 7,871,709, 8,598,264, 8,673,451, 8,685,539, 9,499,723, 9,650,548, 9,662,864, 9,676,971, 9,803,074, 10,053,574, 10,150,894, 10,240,072, and 10,266,727, all of which, the contents are incorporated by reference herein in their entirety.

The functional groups included in the functionalized polymer-based adhesive composition are selected for having miscibility and/or compatibility with the barrier layer composition. The low polarity polymer portion of the functionalized polymer-based adhesive composition are selected for having miscibility and/or compatibility with the structural layer composition.

Tie layer compositions intentionally contain one or more component polymers that are miscible and/or compatible with the layers that are adjacent to each side of the tie layer, wherein such adjacent layers are not miscible and/or compatible with one another. Although this miscibility and/or compatibility of the tie layer with adjacent layers, such as incompatible structural and barrier layers, is sufficient to provide adhesion between the layers to maintain structural integrity of the multilayer structure, it is insufficient to compatibilize the melted blend of incompatible layers as is accomplished by the compatibilizers disclosed herein. Polymer Recyclate

In some embodiments, polymer recyclate herein comprises a mixture of at least one barrier layer and at least one structural layer. In some embodiments, polymer recyclate herein comprises a mixture of a low polarity polymer component and a high polarity polymer component, such as produced by melting and mixing a multilayer barrier film having at least one layer of a low polarity polymer component and at least one layer of a high polarity polymer component.

In some embodiments, polymer recyclate herein comprises a mixture of a low polarity polymer component and a high polarity polymer component, such as produced by melting and mixing a multilayer barrier film having at least one layer of a low polarity polymer and at least one layer of a high polarity polymer component.

In some embodiments, polymer recyclate herein comprises a mixture of a low polarity polymer component, and a high polarity polymer component, such as produced by melting and mixing a multilayer barrier film having at least one layer of a low polarity polymer, and at least one layer of a high polarity polymer component, or alternatively, having at least one layer comprising a blend of at least one polyolefin and at least one low polarity polymer (other than a polyolefin) and at least one layer of a high polarity polymer component.

Polymer recyclate is produced by subjecting any of the multilayer barrier films as described above to compounding conditions sufficient to form a polymer product having a dispersed phase of domains of the high polarity polymer component in a matrix phase comprising the first low polarity polymer. In some embodiments, compounding conditions are implemented in the compounding zone of an extruder or mixer and are tailored for mixtures of specific low polarity polymers, and optionally additives. Temperature, pressure, and shear force conditions are implemented in the extruder or mixer sufficient to provide intimate mixing of the at least one barrier layer and the at least one structural layer or the at least one layer of a high polarity polymer and at least one layer of a low polarity polymer to produce a substantially homogeneous polymer blend of the layers of the multilayer barrier film. The compounding conditions will be such that the specific energy from the compounder from shear and/or added heat are sufficient to melt the polymer components and homogenize them. In some embodiments, compounding conditions comprise a temperature in the compounding zone of less than or equal to 300° C., less than or equal to 250° C. or less than or equal to 200° C. In some embodiments, temperatures in the compounding zone can be in the range of from 125° C. to 195° C., from 130° C. to 180° C., or from 135° C. to 165° C. The polymer recyclate can be pelletized for later mixing a compatibilizer as described below or can be blended in the melted state with such compatibilizer.

### Compatibilizer

In some embodiments, a compatibilizer as disclosed herein comprises a modified polymer produced by reacting a polymer with functional groups or monomers, such as acid and/or acid derivative moieties, wherein the polymer has the one or more functional groups or monomers grafted along the polymer chain. In some embodiments the modified polymer is a functionalized polyolefin, functionalized low polarity polymer (including polyolefin), or a combination thereof.

In some embodiments, the second low polarity polymer is a polyolefin such as a polyethylene homopolymer or copolymer. In some embodiments, the polyolefin is a polypropylene homopolymer or copolymer.

In some embodiments, the polymer is a low polarity polymer (other than polyolefin). In some embodiments, the low polarity polymer is a copolymer of ethylene and one or more polar comonomers. In some embodiments, the low polarity polymer is a copolymer of propylene and one or more polar comonomers.

In some embodiments, the functionalized polymer is formed by addition of one or more pendant functional groups to a polymer backbone comprising a low polarity polymer (including polyolefin). The polyolefin can be an ethylene homopolymer or copolymer of ethylene and one or more alpha olefins. The low polarity polymer (other than polyolefin) can be a copolymer of ethylene and one or more alpha mono-olefins comprising polar groups or a copolymer of propylene and one or more alpha mono-olefins comprising polar groups.

In some embodiments, a compatibilizer as disclosed herein comprises a modified low polarity polymer produced by reacting a low polarity polymer with functional groups or monomers, such as acid and/or acid derivative moieties, wherein the low polarity polymer has the one or more functional groups or monomers grafted along the polymer chain.

Functionalized polymers are generally formed by grafting a functional monomer onto the backbone (i.e., main chain) of a low polarity polymer. The composition of the low polarity polymer can be a polyolefin comprising a single ethylene-based polymer, a single propylene-based polymer, a blend of two or more ethylene-based polymers, a blend of two or more propylene-based polymers, or a blend of at least one ethylene-based polymer and at least one propylene-based polymer. Suitable ethylene-based polymers and propylene-based polymers are described below. The one or more polymers selected from ethylene-based polymers, propylene-based polymers, and combinations thereof selected for the composition of the olefin-base polymer can be the same as or different from those chosen for the composition of the polyolefin of the one or more structural layers of the multilayer barrier film.

The functional groups included in the compatibilizer composition are selected for having miscibility and/or compatibility with the barrier layer composition. The low polarity polymer portion of the compatibilizer composition is selected for having miscibility and/or compatibility with the structural layer composition.

The functional monomer can be grafted onto the polarity polymer via processes known to one skilled in the art. For example, the graft may be formed via reactive extrusion processes. Reactive extrusion processes generally include contacting the low polarity polymer with the functional monomer within an extruder or in a solution process to form the functionalized polymer.

The reactive extrusion processes may include any extrusion process known in the art. For example, raw materials (e.g., low polarity polymer and functional monomer) may be fed into a twin screw extruder in a concentration sufficient to form the functionalized low polarity polymer having a target graft content. The reaction to form the functionalized low polarity polymer may occur in the twin screw extruder under constant mixing and kneading, for example. Thus, the functionalized low polarity polymer generally includes a linear backbone of the polarity polymer with randomly distributed branches of the functional monomer, resulting in side chains that are structurally distinct from the main chain/backbone.

In one or more embodiments, the low polarity polymer contacts the functional monomer in the presence of an initiator. Initiators can be selected from those known to one skilled in the art, such as, but not limited to, organic peroxides. However, as discussed previously herein, grafting can take place under high temperature and high shear in absence of an initiator.

In some embodiments, compatibilizers of the invention are conveniently prepared by grafting the low polarity polymer in the substantial absence of solvent. This can be accomplished in a shear-imparting reactor, such as an extruder/reactor. Twin screw extruder/reactors such as those manufactured by Coperion (formerly Werner-Pfleiderer) under the designations ZSK-53, ZSK-83 and ZSK-92 are commonly used. A free radical generating catalyst, such as an organic peroxide catalyst, can be employed but is not necessary. The grafting reaction is carried out at a temperature selected to minimize or avoid rapid vaporization and consequent losses of the graft monomer and any catalyst that may be employed. The graft monomer concentration in the reactor is typically about 1 to about 5 wt. % based on the total reaction mixture weight. A temperature profile where the temperature of the low polarity polymer melt increases gradually through the length of the extruder/reactor up to a maximum in the grafting reaction zone and then decreases toward the reactor exit is preferred. The maximum temperature within the reactor should be such that significant vaporization losses and/or premature decomposition of any peroxide catalyst are avoided. For example, if di-t-butyl peroxide and 2,5-dimethyl-2,5-di-(t-butylperoxy) hexane are used, temperatures within the reactor are maintained at or below about 220° C. Examples of useful peroxide catalysts include: 1,1-bis(t-butylperoxy)cyclohexane; n-butyl-4,4-bis(t-butylperoxy-valerate); 1,1-bis(t-butylperoxy)-3,3,5-trimethylcyclohexane; 2,2-bis(t-butyl-peroxy)butane; dicumylperoxide; t-butylcumylperoxide; alpha,alpha′-bis(t-butylperoxy-preoxy-isopropyl)benzene; di-t-butylperoxide; 2,5-dimethyl-2,5-di(t-butylperoxy) hexane; and the like. The grafting monomer and any catalyst used are preferably added in neat form to the extruder/reactor.

In a preferred embodiment, the functionalized polymer, i.e., functionalized low polarity polymer, is obtained by grafting an ethylenically unsaturated carboxylic acid or derivative, particularly MAH, onto the polymer backbone. The grafting may be accomplished using known procedures in solution, in a fluidized bed reactor, by melt grafting or by irradiation grafting. As used herein, the term grafting denotes covalent bonding of the grafting monomer to the polymer chain.

The functionalized polymer may include the functional monomer in a range of from 0.10 wt. % to 2.9 wt. %, from 0.45 wt. % to 2.8 wt. %, from 0.70 wt. % to 2.7 wt. %, from 1.05 wt. % to 2.6 wt. %, from 1.50 wt. % to 2.5 wt. %, wherein weight percentages are based on the total weight of the compatibilizer.

In some embodiments, the compatibilizer has a melt index (I₂) in the range of from 1.0 dg/min to 12.0 dg/min, from 3.0 dg/min to 11.5 dg/min, from 5.0 dg/min to 11.0 dg/min, from 7.0 dg/min to 10.5 dg/min, or from 9.0 dg/min to 10.0 dg/min

In some embodiments, the compatibilizer has a density in the range of from 0.850 g/cm³ to 0.960 g/cm³, from 0.855 g/cm³ to 0.950 g/cm³, from 0.860 g/cm³ to 0.940 g/cm³, from 0.865 g/cm³ to 0.930 g/cm³, or from 0.870 g/cm³ to 0.920 g/cm³.

In some embodiments, the compatibilizer has a melt elasticity (ER) in the range of from 0.30 to 3.00, from 0.31 to 2.35, from 0.32 to 1.70, from 0.33 to 1.05, or from 0.34 to 0.40.

In some embodiments, the compatibilizer has a melting temperature (Tₘ) in the range of from 51° C. to 145° C., from 52° C. to 125° C., from 53° C. to 105° C., from 54° C. to 85° C., or from 55° C. to 65° C.

### Polymer Component of the Compatibilizer

In some embodiments, a low polarity polymer comprises a polyolefin suitable for such grafting of one or more functional groups, including ethylene homopolymers and copolymers of units derived from ethylene and units derived from one or more of C₃-C₂₀ alpha-olefins or mixtures thereof. In some embodiments, the units derived from the one or more C₃-C₈ alpha-olefin comonomers are present in amounts up to 15 wt. %, based upon the total weight of the copolymer of ethylene. The ethylene homopolymers and copolymers can be produced using either Ziegler Natta catalysts, chromium-based catalysts, or single-site catalysts, e.g., metallocene catalysts. The ethylene homopolymers and copolymers can be produced using a gas phase process, high pressure process, slurry process, or solution process. Ethylene homopolymers and ethylene-C₃-C₈ alpha-olefin copolymers include very low density polyethylene (VLDPE), low density polyethylene (LDPE), linear low density polyethylene (LLDPE), medium density polyethylene (MDPE) and high density polyethylene (HDPE). VLDPE is defined as having a density of 0.860 to 0.910 g/cm³, as measured by ASTM D-1505 “Column Method.” LDPE and LLDPE are defined as having densities in the range of from 0.910 to 0.930 g/cm³. MDPE is defined as having a density of 0.930 to 0.945 g/cm³. HDPE is defined as having a density of at least 0.945 g/cm³, preferably from 0.945 to 0.969 g/cm³. The ethylene homopolymers and copolymers preferably have melt indexes (MIs), as measured by ASTM D 1238, condition 190° C./2.16 kg, from 0.01 to 400 dg/min, preferably, from 0.1 to 200 dg/min, more preferably from 1 to 100 dg/min

In some embodiments, a low polarity polymer suitable for such grafting of one or more functional groups include LDPE homopolymers and/or copolymers of units derived from ethylene and units derived from one or more of C₃-C₁₂ alpha-olefins. Such C₃-C₁₂ alpha-olefins include, but are not limited to, substituted or unsubstituted C₃ to C₁₂ alpha olefins such as propylene, butene, pentene, hexene, heptene, octene, nonene, decene, undecene, dodecane, and isomers thereof. When present, comonomers can be present in amounts up to 15 wt. %, 10 wt. %, or 5 wt. %.

In some embodiments, a low polarity polymer suitable for such grafting of one or more functional groups include LDPE copolymers of units derived from ethylene and units derived from one or more of alpha mono-olefins comprising polar groups, or mixtures thereof. Such alpha mono-olefins comprising polar groups include, but are not limited to, methacrylic acids, esters, nitriles, and amides, such as methacrylic acids, esters (e.g., acetate esters, such as vinyl acetate), nitriles, and amides, such as acrylic acid, methacrylic acid, cyclohexyl methacrylate, methyl acrylate, acrylonitrile, acrylamide, or mixtures thereof. Comonomers can be present in amounts up to 15 wt. %, 10 wt. %, or 5 wt. %.

Such LDPE homopolymers and copolymers can be produced in a high pressure, free-radical polymerization process, such as in one or more tubular reactors, one or more autoclave reactors, or a combination thereof. Operating conditions for the high-pressure process can include, but are not limited to, a pressure in the range of from 70 MPa to 700 MPa and a temperature in the range of from 150° C. to 500° C. Such homopolymers have a high degree of long-chain branching and a density in the range of from 0.910 g/cm³ to 0.940 g/cm³.

LDPE as described above, can be characterized by having: i) a density in the range of from 0.910 g/cm³ to 0.940 g/cm³ or from 0.915 g/cm³ to 0.935 g/cm³; ii) a melt index (2.16 kg, 190° C.) less than or equal to 5.0 g/10 min., less than or equal to 1.0 g/10 min., less than or equal to 0.5 g/10 min., less than or equal to 0.2 g/10 min., or less than or equal to 0.1 g/10 min.; iii) a molecular weight distribution (M_{w}/Mₙ) greater than 4.0, greater than 8.0, or greater than 15, and/or less than 35, less than 30, or less than 25; iv) a weight average molecular weight (M_{w}) greater than or equal to 100,000 daltons, greater than or equal to 150,000 daltons, greater than or equal to 200,000 daltons, or greater than or equal to 250,000 daltons, and/or less than or equal to 600,000 daltons, less than or equal to 500,000 daltons, less than or equal to 400,000 daltons, or less than or equal to 300,000 daltons; and v) a melt elasticity (“ER”) greater than or equal to 1.0, greater than or equal to 1.4, or greater than or equal to 2.0.

In some embodiments, a low polarity polymer comprises a polyolefin suitable for such grafting of one or more functional groups, including polypropylene homopolymers and/or copolymers, including plastomers, having units derived from propylene and units derived one or more of ethylene and C₄-C₁₀ alpha-olefins or mixtures thereof. Preferably, the units derived from one or more of ethylene and C₄-C₁₀ alpha-olefin comonomers are present in amounts up to 35 wt. %, based upon the total weight of the copolymer of propylene. The propylene homopolymers and copolymers can be produced using either Ziegler Natta or single-site catalysts, e.g., metallocene catalysts. The propylene homopolymers and copolymers can be produced using a gas phase process, slurry process, or solution process. In some embodiments, when the propylene polymer is a copolymer, it contains 2 to 6 wt. %, based upon the total weight of the copolymer, of ethylene derived units as a comonomer.

In some embodiments, a low polarity polymer suitable for such grafting of one or more functional groups include polypropylene homopolymers and/or copolymers, including plastomers, having units derived from propylene and units derived from one or more of alpha mono-olefins comprising polar groups, or mixtures thereof. Such alpha mono-olefins comprising polar groups include, but are not limited to, methacrylic acids, esters, nitriles, and amides, such as methacrylic acids, esters (e.g., acetate esters, such as vinyl acetate), nitriles, and amides, such as acrylic acid, methacrylic acid, cyclohexyl methacrylate, methyl acrylate, acrylonitrile, acrylamide, or mixtures thereof. Comonomers can be present in amounts up to 15 wt. %, 10 wt. %, or 5 wt. %. Functional Group of the Compatibilizer

Acid or acid derivative monomers grafted to obtain the modified or functionalized low polarity polymers are ethylenically unsaturated carboxylic acids or acid derivatives, such as acid anhydrides, esters, salts or the like. Useful monomers include but are not limited to: acrylic acid, methacrylic acid, maleic acid, fumaric acid, itaconic acid, citraconic acid, mesaconic acid, maleic anhydride (MAH), 4-methyl cyclohex-4-ene-1,2-dicarboxylic acid anhydride, bicyclo(2.2.2)oct-5-ene-2,3-dicarboxylic acid anhydride, 1,2,3,4,5,8,9,10-octahydronaphthalene-2,3-dicarboxylic acid anhydride, bicyclo(2.2.1)hept-5-ene-2,3-dicarboxylic acid anhydride, tetrahydrophthhalic anhydride, norborn-5-ene-2,3-dicarboxylic acid anhydride, and x-methylbicyclo(2.2.1)hept-5-ene-2,3-dicarboxylic acid anhydride (XMNA).

In some embodiments, functional groups are selected based on miscibility with the high polarity polymer of a barrier layer. Without wishing to be bound by any particular theory, it is believed that the interfacial reaction between the functional groups of the compatibilizer and the polar monomers of the barrier layer high polarity polymer results in a broader distribution of the high polarity polymer in the dispersed phase, wherein the high polarity polymer domains have a smaller particle size; or in one instance, the interfacial reaction between the maleic anhydride groups of the compatibilizer and hydroxyl groups of EVOH of the barrier layer polar polymer results in a broader distribution of the EVOH in the dispersed phase, wherein the EVOH domains have a smaller particle size.

### Compounding the Polymer Recyclate and the Compatibilizer

In some embodiments, the polymer recyclate, the compatibilizer, and optionally one or more antioxidants are mixed and subjected to compounding conditions sufficient to form a polymer product having a dispersed phase of domains of the high polarity polymer component in a matrix phase of the first low polarity polymer component. In some embodiments, compounding conditions are implemented in the compounding zone of an extruder or mixer and are tailored for mixtures of specific low polarity polymers, and optionally additives. Temperature, pressure, and shear force conditions are implemented in the extruder or mixer sufficient to provide intimate mixing of the at least one barrier layer and the at least one structural layer or the at least one layer of a low polarity polymer and at least one layer of a high polarity polymer component comprising at least one polar monomer produce a substantially homogeneous polymer blend of the layers of the multilayer barrier film. In some embodiments, compounding conditions comprise a temperature in the compounding zone of less than or equal to 300° C., less than or equal to 250° C. or less than or equal to 200° C. In some embodiments, temperatures in the compounding zone can be in the range of from 125° C. to 195° C., from 130° C. to 180° C., or from 135° C. to 165° C. The polymer recyclate can be pelletized for later mixing a compatibilizer as described below or can be blended in the melted state with such compatibilizer.

In some embodiments, the compatibilizer and the high polarity polymer are present in the composition in a weight ratio in a range of from 0.5:1.0 to 5.0:1.0, from 1.0:1.0 to 4.5:1.0, from 1.5:1.0 to 4.0:1.0, from 1.7:1.0 to 3.5:1.0, or from 1.9:1.0 to 3.0:1.0.

In some embodiments, the domains of the high polarity polymer have an average particle size having a cross-sectional area of less than or equal to 0.90 μm², or in the range of from 0.0001 μm² to 0.50 μm², from 0.0002 μm² to 0.25 μm², from 0.0003 μm² to 0.125 μm², from 0.0004 μm² to 0.0625 μm², or from 0.0005 μm² to 0.0313 μm².

### Antioxidants

In some embodiments, primary and/or secondary antioxidants are added to stabilize the reactions for any exposure to oxygen during compounding.

Primary antioxidants react rapidly with peroxy and alkoxy radicals. Examples of primary antioxidants, sometimes termed “long-term antioxidants,” include phenolic antioxidants and hindered amine antioxidants, such as are disclosed in U.S. Pat. No. 6,392,056, the disclosure of which is incorporated herein in its entirety. Suitable primary antioxidants include, but are not limited to, Irganox™ antioxidants available from BASF, such as Irganox™ 1010, Irganox™ 1076, Irganox™ 1098, Irganox™ 1330, Irganox™ 1425 WL, Irganox™ 3114, Irganox™ 245 and Irganox™ 1135. Examples of suitable antioxidants, including phenolic antioxidants and hindered amine antioxidants, are described in U.S. Pat. No. 7,285,617, the disclosure of which is incorporated herein in its entirety.

Nonlimiting examples of primary antioxidants include 2,6-di-tert.butyl-4-methyl phenol, pentaerythrityl-tetrakis(3-(3′,5′-di-tert.butyl-4-hydroxyphenyl)-propionate, octadecyl 3-(3′,5′-di-tert.butyl-4-hydroxyphenyl)propionate, 1,3,5-tri-methyl-2,4,6-tris-(3,5-di-tert.butyl-4-hydroxyphenyl)benzene, 1,3,5-tris(3′,5′-di-tert.butyl-4′-hydroxybenzyl)-isocyanurate, bis-(3,3-bis-(4-′-hydroxy-3′-tert.butylphenyl)butanic acid)-glycolester, N,N′-hexamethylene bis(3,5-di-tert.butyl-4-hydroxy-hydrocinnamamide, 2,5,7,8-Tetramethyl-2(4′,8′,12′-trimethyltridecyl)chroman-6-ol, 2,2′-ethylidenebis(4,6-di-tert.butylphenol), 1,1,3-tris(2-methyl-4-hydroxy-5-tert.butylphenyl) butane, 1,3,5-tris(4-tert.butyl-3-hydroxy-2,6-dimethylbenzyl)-1,3,5-triazine-2,4,-6-(1H,3H,5H)-trione, 3,9-bis(1,1-dimethyl-2-(β-(3-tert.butyl-4-hydroxy-5-methylphenyl) propionyloxy)ethyl)-2,4,8,10-tetraoxaspiro(5,5) undecane, 1,6-hexanediyl-bis(3,5-bis(1,1-dimethylethyl)-4-hydroxybenzene-propanoate-), 2,6-di-tert.butyl-4-nonylphenol, 4,4′-butylidenebis(6-tert.butyl-3-methylphenol), 2,2′-methylene bis(4-methyl-6-tert.butylphenol), and triethyleneglycol-bis-(3-tert.butyl-4-hydroxy-5 methylphenyl) propionate.

Secondary antioxidants, sometimes termed “short-term antioxidants,” can be added to the mixer/extruder at any convenient location. Secondary antioxidants are available commercially, such as the Irgafos™ antioxidants available from BASF, such as Irgafos™ 168, Irgafos™ 126, Irganox™ PS 800 and Irganox™ PS 802.

Examples of secondary antioxidants include, for example, aliphatic thiols and phosphites and phosphonites. Specific examples of secondary antioxidants include distearyl pentaerythritol diphosphite, isodecyl diphenyl phosphite, diisodecyl phenyl phosphite, tris(2,4-di-t-butylphenyl)phosphite, dilauryl-β,β-thiodipropionate, β-naphthyl disulfide, thiol-β-naphthol, 2-mercaptobenzothiazole, benzothiazyl disulfide, phenothiazine, tris(p-nonylphenyl)phosphite, and zinc dimethyldithiocarbamate.

### Applications

In some embodiments, the polymer product herein, comprising the compounded mixture of the polymer recyclate and the compatibilizer, can be used as a substitute for virgin polymers as one or more layers in a multilayer film wherein one or more other layers are virgin polymers. In some embodiments, the polymer product herein, comprising the compounded mixture of the polymer recyclate and the compatibilizer, can be used as a component to be blended with one or more virgin polymers to form one or more layers in a multilayer film. The reduced domain size of the high polarity polymer dispersed phase in the low polarity matrix produces mechanical performance of such multilayer films competitive with, equal to, or better than comparable multilayer films comprising only virgin polymers. Such mechanical performance includes tear strength, dart drop, gloss, and haze. The polymer product disclosed herein, comprising the compounded mixture of the polymer recyclate and the compatibilizer, has improved processibility as compared to polymer recyclates prior to addition of the compatibilizer, believed to result from the reduced particle size of the dispersed phase of high polarity polymer in the low polarity polymer matrix.

### Certain Embodiments

In some embodiments, a composition comprises a mixture of a polymer recyclate and a compatibilizer. The polymer recyclate comprises a first low polarity component and a high polarity polymer component comprising at least one polar monomer. The compatibilizer comprises a second low polarity polymer grafted with one or more functional groups. The mixture is subjected to compounding conditions sufficient to form a polymer product having a dispersed phase of domains of the high polarity polymer component in a matrix phase of the first low polarity polymer component.

In some embodiments of the composition, in addition to the above limitations of the foregoing embodiments of the composition, the high polarity polymer has an oxygen vapor transmission rate (OVTR), as measured by ASTM D3895, of less or equal to 200 cc·μm/m²·day·atm, less than or equal to 150 cc·μm/m²·day·atm, less than or equal to 100 cc·μm/m²·day·atm, or less than or equal to 50 cc·μm/m²·day·atm.

In some embodiments of the composition, in addition to one of more of the above limitations, the first low polarity polymer and the second low polarity polymer each have an oxygen vapor transmission rate (OVTR), as measured by ASTM D3895, of greater than or equal to 800 cc·μm/m²·day·atm, greater than or equal to 900 cc·μm/m²·day·atm, or greater than or equal to 1,000 cc·μm/m²·day·atm.

In some embodiments of the composition, in addition to one of more of the above limitations of the foregoing embodiments of the composition, the first low polarity polymer comprises: a copolymer of units derived from ethylene and units derived from one or more of C₃-C₂₀ alpha-olefins or mixtures thereof, a copolymer of units derived from ethylene and units derived from one or more of alpha mono-olefins comprising polar groups; or combinations thereof.

In some embodiments of the composition, in addition to one of more of the above limitations, the high polarity polymer comprises one or more members selected from the group consisting of ethylene vinyl alcohol, polyamide, polyvinylidene chloride, or polychlorotrifluoroethylene.

In some embodiments of the composition, in addition to one of more of the above limitations of the foregoing embodiments of the composition, the compatibilizer has one or more of:
a) a functional monomer content in a range of from 1.1 wt. % to 2.9 wt. %, from 1.2 wt. % to 2.8 wt. %, from 1.3 wt. % to 2.7 wt. %, from 1.4 wt. % to 2.6 wt. %, from 1.5 wt. % to 2.5 wt. %, wherein weight percentages are based on the total weight of the compatibilizer;
b) a melt index (I₂) in the range of from 1.0 dg/min to 12.0 dg/min, from 3.0 dg/min to 11.5 dg/min, from 5.0 dg/min to 11.0 dg/min, from 7.0 dg/min to 10.5 dg/min, or from 9.0 dg/min to 10.0 dg/min;
c) a density in the range of from 0.850 g/cm³ to 0.960 g/cm³, from 0.855 g/cm³ to 0.950 g/cm³, from 0.860 g/cm³ to 0.940 g/cm³, from 0.865 g/cm³ to 0.930 g/cm³, or from 0.870 g/cm³ to 0.920 g/cm³;
d) a melt elasticity (ER) in the range of from 0.30 to 3.00, from 0.31 to 2.35, from 0.32 to 1.70, from 0.33 to 1.05, or from 0.34 to 0.40; and
e) a melting temperature (Tₘ) in the range of from 51° C. to 145° C., from 52° C. to 125° C., from 53° C. to 105° C., from 54° C. to 85° C., or from 55° C. to 65° C.

In some embodiments of the composition, in addition to one of more of the above limitations of the foregoing embodiments of the composition, the composition is characterized by one or more of the following:
a) the second low polarity polymer comprises an ethylene-based polymer, and the one or more functional groups comprise a member selected from the group consisting of an anhydride, a carboxylic acid, and combinations thereof,
b) the first low polarity polymer is miscible with the second low polarity polymer, and the at least one polar monomer has interfacial reactivity with the one or more functional groups;
c) the domains of the high polarity polymer have an average particle size having a cross-sectional area of less than or equal to 0.90 μm²;
d) the compatibilizer and the high polarity polymer are present in the composition in a weight ratio in a range of from 0.5:1.0 to 5.0:1.0, from 1.0:1.0 to 4.5:1.0, from 1.5:1.0 to 4.0:1.0,from 1.7:1.0 to 3.5:1.0, or from 1.9:1.0 to 3.0:1.0; and
e) the first low polarity polymer comprises a first polyethylene, the high polarity polymer comprises an ethylene vinyl alcohol copolymer, and the compatibilizer comprises a second polyethylene grafted with maleic anhydride, wherein the first polyethylene and the second polyethylene are the same or different.

In some embodiments, a method for recycling a barrier film comprises compounding the barrier film to form a polymer recyclate comprising a substantially homogeneous first mixture of the first low polarity polymer component and the high polarity polymer component. The barrier film comprises at least one layer of a first low polarity polymer component and at least one layer comprising a high polarity polymer component comprising at least one polar monomer. A compatibilizer is added to the polymer recyclate to form a second mixture, wherein the compatibilizer comprises a second low polarity polymer component grafted with one or more functional groups. The second mixture is subjected to compounding conditions sufficient to form a polymer product having a dispersed phase of domains of the high polarity polymer in a matrix phase of the first low polarity polymer component.

In some embodiments of the method, in addition to the above limitations of the foregoing embodiments of the method, the high polarity polymer has an oxygen vapor transmission rate (OVTR), as measured by ASTM D3895, of less or equal to 200 cc·μm/m²·day·atm, less than or equal to 150 cc·μm/m²·day·atm, less than or equal to 100 cc·μm/m²·day·atm, or less than or equal to 50 cc·μm/m²·day·atm.

In some embodiments of the method, in addition to one of more of the above limitations, the first low polarity polymer and the second low polarity polymer each have an oxygen vapor transmission rate (OVTR), as measured by ASTM D3895, of greater than or equal to 800 cc·μm/m²·day·atm, greater than or equal to 900 cc·μm/m²·day·atm, or greater than or equal to 1,000 cc·μm/m²·day·atm.

In some embodiments of the method, in addition to one of more of the above limitations of the foregoing embodiments of the method, the first low polarity polymer comprises: a copolymer of units derived from ethylene and units derived from one or more of C₃-C₂₀ alpha-olefins or mixtures thereof, a copolymer of units derived from ethylene and units derived from one or more of alpha mono-olefins comprising polar groups; or combinations thereof.

In some embodiments of the method, in addition to one of more of the above limitations, the high polarity polymer comprises one or more members selected from the group consisting of ethylene vinyl alcohol, polyamide, polyvinylidene chloride, or polychlorotrifluoroethylene.

In some embodiments of the method, in addition to one of more of the above limitations of the foregoing embodiments of the method, the compatibilizer has one or more of:
a) a functional monomer content in a range of from 1.1 wt. % to 2.9 wt. %, from 1.2 wt. % to 2.8 wt. %, from 1.3 wt. % to 2.7 wt. %, from 1.4 wt. % to 2.6 wt. %, from 1.5 wt. % to 2.5 wt. %, wherein weight percentages are based on the total weight of the compatibilizer;
b) a melt index (I₂) in the range of from 1.0 dg/min to 12.0 dg/min, from 3.0 dg/min to 11.5 dg/min, from 5.0 dg/min to 11.0 dg/min, from 7.0 dg/min to 10.5 dg/min, or from 9.0 dg/min to 10.0 dg/min;
c) a density in the range of from 0.850 g/cm³ to 0.960 g/cm³, from 0.855 g/cm³ to 0.950 g/cm³, from 0.860 g/cm³ to 0.940 g/cm³, from 0.865 g/cm³ to 0.930 g/cm³, or from 0.870 g/cm³ to 0.920 g/cm³;
d) a melt elasticity (ER) in the range of from 0.30 to 3.00, from 0.31 to 2.35, from 0.32 to 1.70, from 0.33 to 1.05, or from 0.34 to 0.40; and
e) a melting temperature (Tₘ) in the range of from 51° C. to 145° C., from 52° C. to 125° C., from 53° C. to 105° C., from 54° C. to 85° C., or from 55° C. to 65° C.

In some embodiments of the method, in addition to one of more of the above limitations of the foregoing embodiments of the method, the method is characterized by one or more of the following:
a) the second low polarity polymer comprises an ethylene-based polymer, and the one or more functional groups comprise a member selected from the group consisting of an anhydride, a carboxylic acid, and combinations thereof,
b) the first low polarity polymer is miscible with the second low polarity polymer, and the at least one polar monomer has interfacial reactivity with the one or more functional groups;
c) the domains of the high polarity polymer have an average particle size having a cross-sectional area of less than or equal to 0.90 μm²;
d) the compatibilizer and the high polarity polymer are present in the composition in a weight ratio in a range of from 0.5:1.0 to 5.0:1.0, from 1.0:1.0 to 4.5:1.0, from 1.5:1.0 to 4.0:1.0,from 1.7:1.0 to 3.5:1.0, or from 1.9:1.0 to 3.0:1.0; and
e) the first low polarity polymer comprises a first polyethylene, the high polarity polymer comprises an ethylene vinyl alcohol copolymer, and the compatibilizer comprises a second polyethylene grafted with maleic anhydride, wherein the first polyethylene and the second polyethylene are the same or different.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Test Methods

Densities are determined in accordance with ASTM D-792 and ASTM D-1505/ISO-1183.

Shear rheological measurements are performed in accord with ASTM 4440-95a, which characterize dynamic viscoelastic properties (storage modulus, G′, loss modulus, G″ and complex viscosity, η*, as a function of oscillation frequency, ω). A rotational rheometer (TA Instruments) is used for the rheological measurements. A 25 mm parallel-plate fixture was utilized. Samples were compression molded in disks (˜29 mm diameter and ˜1.3 mm thickness) using a hot press at 190° C. An oscillatory frequency sweep experiment (from 398.1 rad/s to 0.0251 rad/s) was applied at 190° C. The applied strain amplitude is ˜10% and the operating gap is set at 1 mm. Nitrogen flow was applied in the sample chamber to minimize thermal oxidation during the measurement.
Dart drop (g): Measurements were made following ASTM D1709-04 (2016), using a dart drop height of 26 in (F50).
Elongation at break (%): Elongation at break was measured according to ASTM D-638.
Film Elmendorf Tear (g/mil) was made according to ASTMD 1922.
Gloss (45°) is measured as specified by ASTM D2457.
Haze (%): Film haze measurements were made following ASTM D1003.

Melt elasticity (“ER”) is determined as discussed in R. Shroff and H. Mavridis, “New Measures of Polydispersity from Rheological Data on Polymer Melts”, J. Applied Polymer Science 57 (1995) 1605. See also U.S. Pat. Nos. 7,238,754, 6,171,993 and 5,534,472 (col. 10, lines 20-30), the teachings of which are incorporated herein by reference. Thus, storage modulus (G′) and loss modulus (G″) are measured. The nine lowest frequency points are used (five points per frequency decade) and a linear equation is fitted by least-squares regression to log G′ versus log G″. ER is then calculated from:

$$ER = ( 1.781 \times {10}^{- 3} ) \times {G}^{′}$$

at a value of G″=5,000 dyn/cm². The same procedure and equation for the ER calculation was used for both linear and long-chain-branched polyolefins.

Melt index (“I₂”) was determined by ASTM D-1238-E (190° C./2.16 kg).

Molecular weight distribution (“MWD”) as well as the molecular weight averages (number-average molecular weight, Mₙ weight-average molecular weight, M_{w}, and z-average molecular weight, M_{z}) are determined using a high temperature Polymer Char gel permeation chromatography (“GPC”), also referred to as size exclusion chromatography (“SEC”), equipped with a filter-based infrared detector, IR5, a four-capillary differential bridge viscometer, and a Wyatt 18-angle light scattering detector. Mₙ, M_{w}, M_{z}, MWD, and short chain branching (SCB) profiles are reported using the IR detector, whereas long chain branch parameter, g′, is determined using the combination of viscometer and IR detector at 145° C. Three Agilent PLgel Olexis GPC columns are used at 145° C. for the polymer fractionation based on the hydrodynamic size in 1,2,4-trichlorobenzene (TCB) with 300 ppm antioxidant butylated hydroxytoluene (BHT) as the mobile phase. 16 mg polymer is weighted in a 10 mL vial and sealed for the GPC measurement. The dissolution process is obtained automatically (in 8 ml TCB) at 160° C. for a period of 1 hour with continuous shaking in an Agilent autosampler. 20 μL Heptane was also injected in the vial during the dissolution process as the flow marker. After the dissolution process, 200 μL solution was injected in the GPC column. The GPC columns are calibrated based on twelve monodispersed polystyrene (PS) standards (provided by PSS) ranging from 578 g/mole to 3,510,000 g/mole. The comonomer compositions (or SCB profiles) are reported based on different calibration profiles obtained using a series of relatively narrow polyethylene (polyethylene with 1-hexene and 1-octene comonomer were provided by Polymer Char, and polyethylene with 1-butene were synthesized internally) with known values of CH₃/1000 total carbon, determined by an established solution NMR technique. GPC one software was used to analyze the data. The long chain branch parameter, g′, is determined by the equation:

$${g}^{′} = [ η ] / [ η ] lin$$

where, [η] is the average intrinsic viscosity of the polymer that is derived by summation of the slices over the GPC profiles as follows:

$$[ η ] = \frac{\sum {{c}_{i} [ η ]}_{i}}{\sum {c}_{i}}$$

where cᵢ is the concentration of a particular slice obtained from IR detector, and [η]ᵢ is the intrinsic viscosity of the slice measured from the viscometer detector. [η]ₗᵢₙ is obtained from the IR detector using Mark-Houwink equation ([η]ₗᵢₙ=ΣMᵢ^{alpha}) for a linear high density polyethylene, where Mᵢ is the viscosity-average molecular weight for a reference linear polyethylene, K and α are Mark-Houwink constants for a linear polymer, which are K=0.000374, α=0.7265 for a linear polyethylene and K=0.00041, α=0.6570 for a linear polypropylene.

Oxygen gas transmission rate (OVTR) can be measured by ASTM D3985.

Narrow Angle Scatter: Film NAS measurements were made following ASTM D1746 (2015) Standard Test Method for Transparency of Plastic Sheeting.

Polar polymer domain size (in the examples herein, EVOH) was measured by Scanning Electron Microscopy (SEM) which is described, for example, in an article to F. Mirabella, et al. entitled “Morphological Explanation of the Extraordinary Fracture Toughness of Linear Low Density Polyethylenes”, J. Polymer Science: Part B: Polymer Physics, Vol. 26, No. 9, August 1988, pp. 1995-2005. Specifically, the following procedure was employed in the present invention to determine the volume percent polar polymer in the barrier film recyclate resin comprising a mixture of nonpolar polymer and polar polymer. A compression-molded sample of the film recyclate resin was microtomed at a specimen temperature of about −80° C. in an LKB Ultratome V with Cryokit. The bulk specimen thus prepared was etched in n-heptane at 60° C. for 20 minutes in a sonic bath, mounted onto a scanning electron microscope specimen stub, and sputter coated with approximately 200 A of gold. The specimen was then analyzed in an ISI-40 SEM. This procedure removes any rubbery, amorphous or low-crystallinity, in the resin from the specimen surface and leaves definable cavities where the material was originally located. Photomicrographs were statistically analyzed with a Ziess Videoplan Image Analyzer.

Tensile stress at break (MPa): Tensile stress at break was measured according to ASTM D-638. This test is dependent on film sample thickness. For the measurements provided here, a thickness of about 46 μm to 55 μm was used.

### Materials Used in Experiments

### Starting Materials

Starting materials for Examples 1-14 are shown in TABLE 1 below. Nonpolar polymer NP1 was used as skin layers of a multilayer barrier film prepared as a proxy for recycled barrier films. Polar polymer PP1 was used as a core layer of multilayer the barrier film. Functionalized polymer FP1 was used as tie layers between the skin layers and core layer of multilayer the barrier film. Linear low density polyethylene LL1 was used in one or more layers of multilayer films prepared using a layer of neat or compatibilized recyclate. Antioxidants AO1 and AO2 were used in polymer compounds including neat or compatibilized recyclate.

TABLE 1

| | | | Density | MI (I₂) | |
|---|---|---|---|---|---|
| Label | Composition | Grade | (g/cm³) | (dg/min) | Available from |
| NP1 | High density | Petrothene ™ | 0.960 | 0.80 | LyondellBasell, 1221 McKinney |
| | polyethylene (HDPE) | LM600700 | | | Street # 300, Houston, TX |
| | | | | | 77010, USA |
| PP1 | Ethylene vinyl | Soarnol ™ | 1.19 | 3.8 | Mitsubishi Chemical Group, |
| | alcohol copolymers | EVOH | | | 9115 Harris Corners Parkway, |
| | (EVOH) | DC3203FB | | | Suite 300. Charlotte, NC |
| | | | | | 28269, USA |
| FP1 | HDPE-g-MAH | Plexar ™ | 0.922 | 2.0 | LyondellBasell, 1221 Mckinney |
| | | PX3236 | | | Street # 300, Houston, TX |
| | | | | | 77010, USA |
| LL1 | Linear low density | Petrothene ™ | 0.918 | 1.0 | LyondellBasell, 1221 Mckinney |
| | PE (LLDPE) | GA601030 | | | Street # 300, Houston, TX |
| | | | | | 77010, USA |
| AO1 | sterically hindered | Irganox ™ | n/a | n/a | BASF, 100 Park Avenue, Florham |
| | phenolic primary | 1010FF | | | Park, NJ 07932, USA |
| | antioxidant | | | | |
| AO2 | hydrolytically | Irgafos ™ | n/a | n/a | BASF, 100 Park Avenue, Florham |
| | stable phosphite | 168FF | | | Park, NJ 07932, USA |
| | processing stabilizer; | | | | |
| | secondary antioxidant | | | | |

### Recyclate

Multilayer films of virgin polymers were used as a proxy for recycled barrier film. The multilayer films were prepared by conventional coextrusion and had thickness of from about 44 μm to about 50 μm. The compositional structure of the C/B/A/B/C multilayer film is shown in TABLE 1 below.

TABLE 2

| | Layer/ | |
|---|---|---|
| Layer | Film (%) | Composition |
| C | 37 | Nonpolar polymer NP1 |
| B | 8 | Functionalized polymer FP1 |
| A | 10 | Polar polymer PP1 |
| B | 8 | Functionalized polymer FP1 |
| C | 37 | Nonpolar polymer NP1 |

The above multilayer film was melted in an extruder and pelletized as a proxy for pelletized barrier film recyclate and labeled as post-consumer recyclate PCR1 in the examples below. Mixing in the extruder was sufficient to form pellets having an average size in the range of from 20 to 60 pellets per gram, wherein the pellets were compositionally equivalent.

### Compatibilizers

TABLE 3 shows the composition of the compatibilizers used in the examples below.

TABLE 3

| Compatibilizer | C1 | C2 | C3 |
|---|---|---|---|
| MI (I₂) (dg/min) | 9.5 | 10.0 | 9.0 |
| Maleic Anhydride (wt. %) | 1.85 | 2.00 | 1.00 |
| Density (g/cm³) | 0.95 | 0.87 | 0.93 |
| ER | 0.70 | 0.37 | 2.92 |
| Melting Temp (° C.) | 129 | 60 | 126 |

### Examples 1-7

EVOH domain size was measured in Examples 1-7 using a Scanning Electron

Microscope (SEM). Table 4 shows the reduction in EVOH domain size in recyclate PCR1 blended with compatibilizers at various ratios compared to recyclate PCR1 without a compatibilizer. Comparative Example 1 shows that neat PCR1 has an EVOH mean domain size of 0.97 μm² and an EVOH median domain size of 1.00 μm².

Examples 2-4 surprisingly show blends of PCR1 with compatibilizer C1, wherein the molar ratio of MAH to VOH in the blends are 1:1, 2:1, and 3:1, respectively. Example 2 has a mean EVOH domain size of 0.131 μm², an 86.5% reduction, and a median EVOH domain size of 0.110 μm², an 89.0% reduction. Example 3 has a mean EVOH domain size of 0.053 μm², an 94.6% reduction, and a median EVOH domain size of 0.030 μm², an 97.0% reduction. Example 4 has a mean EVOH domain size of 0.048 μm², an 95.1% reduction, and a median EVOH domain size of 0.020 μm², an 98.0% reduction.

Examples 5-7 surprisingly show blends of PCR1 with compatibilizer C2, wherein the molar ratio of MAH to VOH in the blends are 1:1, 2:1, and 3:1, respectively. Example 5 has a mean EVOH domain size of 0.028 μm², an 97.2% reduction, and a median EVOH domain size of 0.020 μm², an 98.0% reduction. Example 6 has a mean EVOH domain size of 0.012 μm², an 98.8% reduction, and a median EVOH domain size of 0.010 μm², an 99.0% reduction. Example 7 has a mean EVOH domain size of 0.00133 μm², an 99.9% reduction, and a median EVOH domain size of 0.00082 μm², an 99.9% reduction.

It is believed, without wishing to be bound by any particular theory, that the lower density, ER, and melting temperature of compatibilizer C2, as compared to compatibilizer C1 led to improved performance in reducing the EVOH domain sizes in blends with recyclate PCR1.

TABLE 4

| Example | | 1 | 2 | 3 | 4 | 5 | 6 | 7 |
|---|---|---|---|---|---|---|---|---|
| Compatibilizer | | None | C1 | C1 | C1 | C2 | C2 | C2 |
| Compatibilizer:EVOH (wt. %/wt. %) | | N/A | 1:1 | 2:1 | 3:1 | 1:1 | 2:1 | 3:1 |
| Area of EVOH | Mean | 0.97 | 0.131 | 0.053 | 0.048 | 0.028 | 0.012 | 0.00133 |
| Domains (μm²) | Median | 1.00 | 0.110 | 0.030 | 0.020 | 0.020 | 0.010 | 0.00082 |

### Examples 8-14

Table 5 below shows polymer compounds PC1-PC5 comprising recyclate PCR1. Polymer compounds PC1-PC5 are used as core layers in multilayer film Examples 9-14. The reduction in EVOH domain size in recyclate PCR1 blended with compatibilizers at various ratios compared to recyclate PCR1 without a compatibilizer. Comparative Example 1 shows that neat PCR1 has an EVOH mean domain size of 0.97 μm² and an EVOH median domain size of 1.00 μm².

TABLE 5

| Components of Polymer Compounds | PC1 | PC2 | PC3 | PC4 | PC5 |
|---|---|---|---|---|---|
| Recyclate PCR1 (wt. %) | 99.6 | 83 | 83 | 83 | 83 |
| Compatibilizer C2 (wt. %) | — | 8.3 | 16.6 | — | — |
| Compatibilizer C3 (wt. %) | — | — | — | 8.3 | 16.6 |
| Antioxidant AO1 | 0.2 | 0.2 | 0.2 | 0.2 | 0.2 |
| Antioxidant AO2 | 0.2 | 0.2 | 0.2 | 0.2 | 0.2 |
| EVOH (wt. %) | 9.96 | 8.3 | 8.3 | 8.3 | 8.3 |
| Compatibilizer to EVOH | — | 1:1 | 2:1 | 1:1 | 2:1 |
| (wt. %:wt. %) | | | | | |

Three-layer films of A/B/A configuration were prepared in Examples 8-14 to demonstrate the relative performance of films comprising virgin polymers, films comprising recyclate, and films comprising compatibilized recyclate. Each film sample was prepared using the conditions shown in Table 6 below.

TABLE 6

| Film Production Parameters | Value |
|---|---|
| Layers | 3 |
| Blow Up Ratio (1.0-3.5) | 2 |
| Die Gap (40, 60, 80 mil) | 60 |
| Die Gap (1.02, 1.52, 2.03 mm) | 1.52 |
| Output (5-25 kg/hr) | 15 |
| Lay Flat Width (3.7-12.6″) | 9 |
| Lay Flat Width (9.4-32.0 cm) | 22.9 |
| Gauge (mil) | 2 |
| Gauge (μm) | 50.8 |
| Frostline (cm) | 16 |
| Screen Pack | 20/60/100/20 |

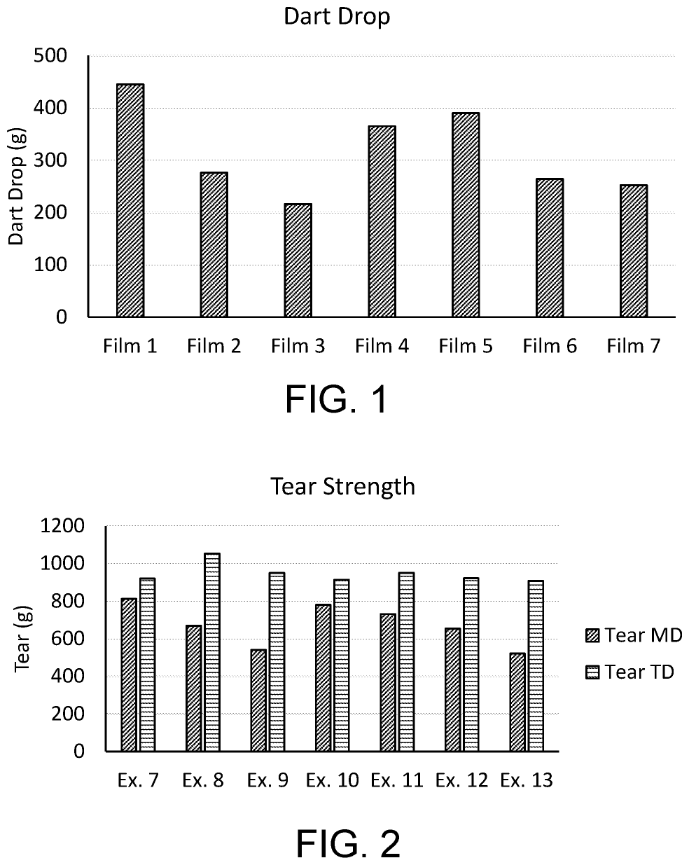

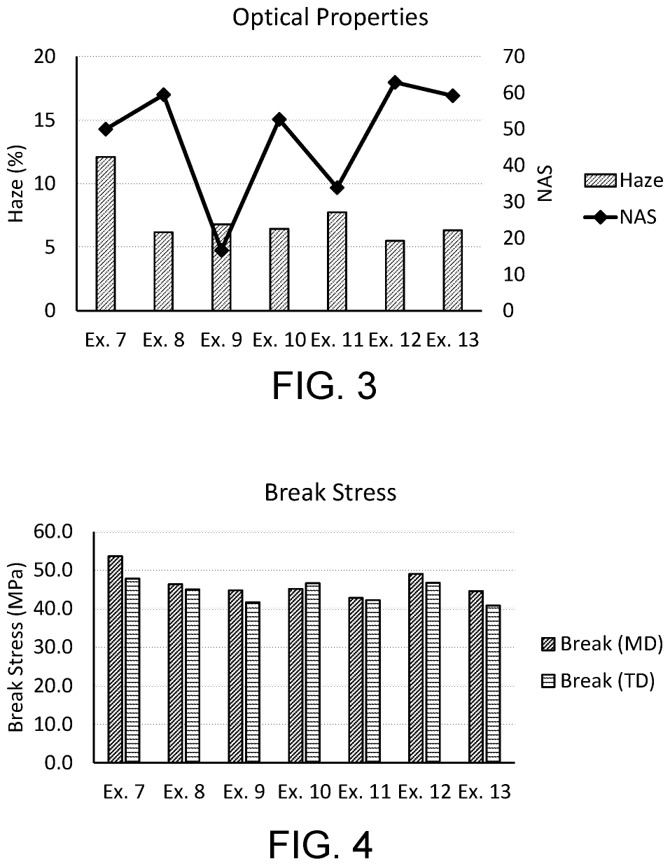

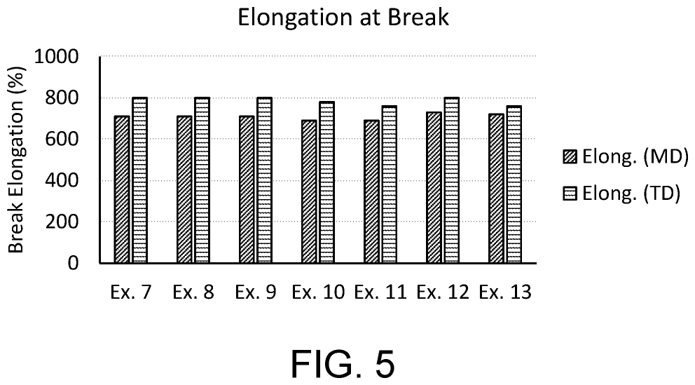

Table 7 shows the compositions and mechanical performance of Examples 8-14. Test result values are the average of 5 experiments under the same conditions. Skin layers A in the A/B/A film configurations in Examples 8-14 comprised linear low-density polyethylene LL1. The core layer B in Example 8 was linear low-density polyethylene LL1. Example 8 provides benchmark performance of a films comprising only virgin polymers. Examples 9 and 10 show the performance of films where the core layer B was polymer compound PC1, comprising recyclate PCR1 without a compatibilizer. Examples 11 and 12 show the performance of films where the core layer B was polymer compound PC2 and PC3, respectively, comprising recyclate PCR1 with compatibilizer C2. Examples 13 and 14 show the performance of films where the core layer B was polymer compound PC4 and PC5, respectively, comprising recyclate PCR1 with compatibilizer C3. FIG. 1 shows a graphical representation of the dart drop performance of Examples 8-14. FIG. 2 shows a graphical representation of the tear strength performance of Examples 8-14. FIG. 3 shows a graphical representation of the optical properties of Examples 8-14. FIG. 4 shows a graphical representation of the tensile break performance of Examples 8-14. FIG. 5 shows a graphical representation of the tensile elongation at break performance of Examples 8-14.

TABLE 7

| Example | | 8 | 9 | 10 | 11 | 12 | 13 | 14 |
|---|---|---|---|---|---|---|---|---|
| Compatibilizer | | None | None | None | C2 | C2 | C3 | C3 |
| Skin layer A | Thickness | 42.5% | 42.5% | 35% | 42.5% | 35% | 42.5% | 35% |
| | Composition | LL1 | LL1 | LL1 | LL1 | LL1 | LL1 | LL1 |
| Core layer B | Thickness | 15% | 15% | 30% | 15% | 30% | 15% | 30% |
| | Composition | LL1 | PC1 | PC1 | PC2 | PC3 | PC4 | PC5 |
| Skin layer A | Thickness | 42.5% | 42.5% | 35% | 42.5% | 35% | 42.5% | 35% |
| | Composition | LL1 | LL1 | LL1 | LL1 | LL1 | LL1 | LL1 |
| Avg. Thickness | (μm) | 47.75 | 48.26 | 49.02 | 46.48 | 50.04 | 45.72 | 54.61 |
| Dart Drop | (g) | 445 | 276 | 216 | 365 | 390 | 264 | 252 |
| | (g/μm) | 8.76 | 5.43 | 4.25 | 7.19 | 7.68 | 5.20 | 4.96 |
| MD Tear Strength | (g) | 812 | 669 | 541 | 780 | 731 | 654 | 522 |
| | (g/μm) | 17.00 | 13.87 | 11.03 | 16.79 | 14.62 | 14.30 | 9.55 |
| MD Tear Strength | (g) | 85.3 | 44.4 | 36.9 | 49.1 | 48.7 | 64.3 | 68.2 |
| SD | (g/μm) | 1.79 | 0.92 | 0.75 | 1.06 | 0.97 | 1.41 | 1.25 |
| TD Tear Strength | (g) | 921 | 1054 | 950 | 914 | 951 | 922 | 908 |
| | (g/μm) | 19.3 | 21.8 | 19.4 | 19.7 | 19.0 | 20.2 | 16.6 |
| TD Tear Strength | (g) | 108.3 | 43.7 | 77.8 | 64.4 | 89.9 | 64.4 | 54.7 |
| SD | (g/μm) | 2.27 | 0.91 | 1.59 | 1.39 | 1.80 | 1.41 | 1.00 |
| Haze | % | 12.1 | 6.18 | 6.81 | 6.45 | 7.75 | 5.50 | 6.33 |
| Haze SD | % | 0.7 | 0.57 | 0.53 | 0.24 | 0.64 | 0.12 | 0.6 |
| NAS | degrees | 50 | 59.5 | 16.7 | 52.7 | 33.9 | 62.9 | 59.2 |
| NAS SD | degrees | 0.9 | 4.7 | 0.8 | 6.9 | 4.4 | 2.7 | 1.8 |
| MD Break | MPa | 53.6 | 46.4 | 44.8 | 45.2 | 42.8 | 49.1 | 44.6 |
| MD Break SD | MPa | 5.07 | 4.55 | 1.80 | 4.56 | 5.10 | 1.76 | 3.19 |
| MD Break Elong | % | 710 | 710 | 710 | 690 | 690 | 730 | 720 |
| MD Break Elong | % | 38 | 36 | 21 | 40 | 28 | 13 | 33 |
| SD | | | | | | | | |
| TD Break | MPa | 47.8 | 45.0 | 41.7 | 46.7 | 42.3 | 46.7 | 40.8 |
| TD Break SD | MPa | 5.28 | 2.48 | 2.73 | 2.39 | 1.87 | 3.62 | 7.52 |
| TD Break Elong | % | 800 | 800 | 800 | 780 | 760 | 800 | 760 |
| TD Break Elong | % | 40 | 13 | 24 | 23 | 27 | 29 | 65 |
| SD | | | | | | | | |

Table 7 shows the compositions and mechanical performance of Examples 8-14. Skin layers A in the A/B/A film configurations in Examples 8-14 comprised linear low-density polyethylene LL1. The core layer B in Example 8 was linear low-density polyethylene LL1. Example 8 provides benchmark performance of a films comprising only virgin polymers.

Examples 9 and 10 show the performance of films where the core layer B was polymer compound PC1, comprising recyclate PCR1 without a compatibilizer. The core layers B in Examples 9 and 10 have larger domains of EVOH gels without the use of a compatibilizer, resulting in visual defects and poor optical properties in the final film. Dart drop and tear strength in Example 9, wherein the core layer B of polymer compound PC1 is 15% of the overall film thickness, are 38% lower and 18% lower, respectively, than Example 8. Dart drop and tear strength in Example 10, wherein the core layer B of polymer compound PC1 is 30% of the overall film thickness, are 51% lower and 33% lower, respectively, than Example 8. Both Examples 9 and 10 show poorer dart drop and tear strength than Example 8. However, Example 10, containing a higher proportion of polymer compound PC1, shows poorer dart drop and tear strength than Example 9. Further performance deterioration of the overall film with a higher amount of polymer compound PC1 indicates significantly poorer properties of compound PC1 without compatibilizer.

Examples 11 and 12 show the performance of films where the core layer B was polymer compound PC2 and PC3, respectively, comprising recyclate PCR1 with compatibilizer C2. The core layers B in Examples 11 and 12 have smaller domains of EVOH gels without the use of compatibilizer C2, resulting in less visual defects and improved optical properties in the final film. Dart drop and tear strength in Example 11, wherein the core layer B of polymer compound PC2 is 15% of the overall film thickness, are 18% lower and 4% lower, respectively, than Example 8, but surprisingly show a 32% increase in dart drop and a 17% increase in tear strength relative to Example 9. This demonstrates a surprising improvement in mechanical properties attributable to use of polymer compound PC2 as a core layer B instead of polymer compound PC1. Therefore, use of compatibilizer C2 maintains a favorable balance of film properties while consuming an amount of recyclate PCR1 instead of virgin polymer.

Dart drop and tear strength in Example 12, wherein the core layer B of polymer compound PC3 is 30% of the overall film thickness, are 12% lower and 10% lower, respectively, than Example 8, but surprisingly show a 81% increase in dart drop and a 35% increase in tear strength relative to Example 10. Therefore, use of an increased amount of compatibilizer C2 allows the use of twice the amount of polymer compound PC3, while still maintaining an improved balance of dart drop and tear strength. That is to say, the higher amount of compatibilizer C2 maintains a favorable balance of film properties while consuming a higher amount of recyclate PCR1.

Examples 13 and 14 show the performance of films where the core layer B was polymer compound PC4 and PC5, respectively, comprising recyclate PCR1 with compatibilizer C3. The core layers B in Examples 13 and 14 have smaller domains of EVOH gels without the use of compatibilizer C3, resulting in less visual defects and improved optical properties in the final film. Dart drop and tear strength in Example 13, wherein the core layer B of polymer compound PC4 is 15% of the overall film thickness, are 41% lower and 18% lower, respectively, than Example 8, and show a 4% decrease in dart drop and a 2% decrease in tear strength relative to Example 9.

Dart drop and tear strength in Example 14, wherein the core layer B of polymer compound PC1 is 30% of the overall film thickness, are 12% lower and 10% lower, respectively, than Example 8, but surprisingly show a 17% increase in dart drop and only a 4% decrease in tear strength relative to Example 10. Therefore, use of an increased amount of compatibilizer C3 allows the use of twice the amount of polymer compound PC5, while still maintaining an improved balance of dart drop and tear strength. That is to say, that the higher amount of compatibilizer C3 maintains a favorable balance of film properties while consuming a higher amount of recyclate PCR1.

For the sake of brevity, only certain ranges are explicitly disclosed herein. However, in addition to recited ranges, any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents and references cited herein, including testing procedures, publications, patents, journal articles, etc., are herein fully incorporated by reference for all jurisdictions in which such incorporation is permitted and to the extent such disclosure is consistent with the description of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machines, film structures, composition of layers, means, methods, and/or steps described in the specification. As one of the ordinary skill in the art will readily appreciate from the disclosure of the present invention, processes, machines, film structures, composition of layers, means, methods, and/or steps, presently existing or later to be developed that perform substantially the same function or achieve substantially the same result as the corresponding embodiments described herein, may be utilized according to the present invention. Accordingly, the appended claims are intended to include within their scope such processes, machines, film structures, composition of layers, means, methods, and/or steps.

What is claimed is:

1. A composition comprising a mixture of:
a) a polymer recyclate, comprising a first low polarity polymer having an oxygen vapor transmission rate (OVTR) greater than or equal to 800 cc·μm/m²·day·atm and a high polarity polymer, comprising at least one polar monomer and having an OVTR less than or equal to 200 cc·μm/m²·day·atm;
b) a compatibilizer, comprising a second low polarity polymer grafted with one or more functional groups, wherein the second low polarity polymer has an OVTR greater than or equal to 800 cc·μm/m²·day·atm;
wherein the mixture is subjected to compounding conditions sufficient to form a polymer product having a dispersed phase of domains of the high polarity polymer in a matrix phase of the first low polarity polymer.

2. The composition of claim 1, wherein the first low polarity polymer comprises: a copolymer of units derived from ethylene and units derived from one or more of C₃-C₂₀ alpha-olefins or mixtures thereof, a copolymer of units derived from ethylene and units derived from one or more of alpha mono-olefins comprising polar groups; or combinations thereof.

3. The composition of claim 1, wherein the high polarity polymer comprises one or more members selected from the group consisting of ethylene vinyl alcohol, polyamide, polyvinylidene chloride, or polychlorotrifluoroethylene.

4. The composition of claim 1, wherein the compatibilizer has one or more of:
a) a functional monomer content in a range of from 1.1 wt. % to 2.9 wt. %, based on the total weight of the compatibilizer;
b) a melt index (I₂) in the range of from 1.0 dg/min to 12.0 dg/min;
c) a density in the range of from 0.850 g/cm³ to 0.960 g/cm³;
d) a melt elasticity (ER) in the range of from 0.30 to 3.00; and
e) a melting temperature (Tₘ) in the range of from 51° C. to 145° C.

5. The composition of claim 1, wherein the second low polarity polymer comprises an ethylene-based polymer, and the one or more functional groups comprise a member selected from the group consisting of an anhydride, a carboxylic acid, and combinations thereof.

6. The composition of claim 1, wherein the first low polarity polymer is miscible with the second low polarity polymer, and the at least one polar monomer has interfacial reactivity with the one or more functional groups.

7. The composition of claim 1, wherein the domains of the high polarity polymer have an average particle size having a cross-sectional area of less than or equal to 0.90 μm².

8. The composition of claim 1, wherein the compatibilizer and the high polarity polymer are present in the composition in a weight ratio in a range of from 0.5:1.0 to 5.0:1.0.

9. The composition of claim 1, wherein the first low polarity polymer comprises a first polyethylene, the high polarity polymer comprises an ethylene vinyl alcohol copolymer, and the compatibilizer comprises a second polyethylene grafted with maleic anhydride.

10. The composition of claim 9, wherein the first polyethylene and the second polyethylene are the same or different.

11. A method for recycling a barrier film, wherein the barrier film comprises at least one layer of a first low polarity polymer having an oxygen vapor transmission rate (OVTR) greater than or equal to 800 cc·μm/m²·day·atm and at least one layer comprising a high polarity polymer, comprising at least one polar monomer and having an OVTR less than or equal to 200 cc·μm/m²·day·atm, the method comprising:
a) compounding the barrier film to form a polymer recyclate comprising a substantially homogeneous first mixture of the first low polarity polymer and the high polarity polymer;
b) adding a compatibilizer to the polymer recyclate to form a second mixture, wherein the compatibilizer comprises a second low polarity polymer grafted with one or more functional groups;
c) subjecting the second mixture to compounding conditions sufficient to form a polymer product having a dispersed phase of domains of the high polarity polymer in a matrix phase of the first low polarity polymer.

12. The method of claim 11, wherein the first low polarity polymer comprises: a copolymer of units derived from ethylene and units derived from one or more of C₃-C₂₀ alpha-olefins or mixtures thereof, a copolymer of units derived from ethylene and units derived from one or more of alpha mono-olefins comprising polar groups; or combinations thereof.

13. The method of claim 11, wherein the high polarity polymer comprises one or more members selected from the group consisting of ethylene vinyl alcohol, polyamide, polyvinylidene chloride, or polychlorotrifluoroethylene.

14. The method of claim 11, wherein the compatibilizer has one or more of:
a) a functional monomer content in a range of from 1.1 wt. % to 2.9 wt. %, based on the total weight of the compatibilizer;
b) a melt index (I₂) in the range of from 1.0 dg/min to 12.0 dg/min;
c) a density in the range of from 0.850 g/cm³ to 0.960 g/cm³;
d) a melt elasticity (ER) in the range of from 0.30 to 3.00; and
e) a melting temperature (Tₘ) in the range of from 51° C. to 145° C.

15. The method of claim 11, wherein the second low polarity polymer comprises an ethylene-based polymer, and the one or more functional groups comprise a member selected from the group consisting of an anhydride, a carboxylic acid, and combinations thereof.

16. The method of claim 11, wherein the first low polarity polymer is miscible with the second low polarity polymer, and the at least one polar monomer has interfacial reactivity with the one or more functional groups.

17. The method of claim 11, wherein the domains of the high polarity polymer have an average particle size having a cross-sectional area of less than or equal to 0.90 μm².

18. The method of claim 11, wherein the compatibilizer and the high polarity polymer are present in the composition in a weight ratio in a range of from 0.5:1.0 to 5.0:1.0.

19. The method of claim 11, wherein the first low polarity polymer comprises a first polyethylene, the high polarity polymer comprises an ethylene vinyl alcohol copolymer, and the compatibilizer comprises a second polyethylene grafted with maleic anhydride.

20. The method of claim 19, wherein the first polyethylene and the second polyethylene are the same or different.
